(19) United States
(12) Patent Application Publication
(10) Pub. No.: US 2021/0387388 A1
(43) Pub. Date: Dec. 16, 2021

(54) FORMING MOLD FOR PRESSURE CONTAINER LINER AND MOLDING METHOD FOR PRESSURE CONTAINER LINER

(71) Applicant: TOYOTA JIDOSHA KABUSHIKI KAISHA, Toyota-shi (JP)

(72) Inventor: Youichiro BABA, Miyoshi-shi (JP)

(73) Assignee: TOYOTA JIDOSHA KABUSHIKI KAISHA, Toyota-shi (JP)

(21) Appl. No.: 17/234,904

(22) Filed: Apr. 20, 2021

(30) Foreign Application Priority Data
Jun. 10, 2020 (JP) 2020-100843

(51) Int. Cl. B29C 45/26; B29C 45/34; B29C 45/17

(52) U.S. Cl. CPC B29C 45/261; B29L 2031/7172; B29C 45/1701; B29C 45/34

(57) ABSTRACT

Provided is a forming mold for a pressure container liner including a female serration on an upper face of a top portion. The forming mold includes an insert including a recessed-projecting portion by which the female serration is to be formed. The insert includes a lower layer and an upper layer divided from each other in the up-down direction. Bolt holes are formed in respective radial central parts of the upper layer and the lower layer. Gaps on contacting faces between the upper layer and the lower layer are set to a size that allows gas to pass through the gaps but does not allow nylon resin to pass through the gaps. An air-discharge passage via which a vicinal area of the recessed-projecting portion is connected to the bolt holes is formed on the contacting faces.

### CROSS-REFERENCE TO RELATED APPLICATION

This application claims priority to Japanese Patent Application No. 2020-100843 filed on Jun. 10, 2020, incorporated herein by reference in its entirety.

### BACKGROUND

### 1. Technical Field

The present disclosure relates to a forming mold for a pressure container liner constituting an inner shell of a pressure container and a molding method for the pressure container liner.

### 2. Description of Related Art

In the related art, there has been known a technique for restraining occurrence of welds by reducing branching and merging of molten resin inside a cavity at the time when a pressure container liner is formed by injection molding, such that a film gate is formed between an insert and an outer mold, and the molten resin is poured from the film gate to the whole circumference of the cavity in a film shape.

For example, Japanese Unexamined Patent Application Publication No. 2014-224602 (JP 2014-224602 A)) discloses a forming mold configured as follows. That is, at the time of forming a pressure container liner including, in its top portion, a female serration serving as a fitting part to be fitted in a mouth piece, a film gate is formed between an outer mold and an insert including a recessed-projecting portion by which the female serration is to be formed, and the film gate is connected to a radially outer side of the female serration.

### SUMMARY

In the forming mold described in JP 2014-224602 A, the molten resin expands in a dome shape from a single-point nozzle of an injection molding machine and is supplied from a ring-shaped gate into a cavity at the same time. Then, a flow tip of the molten resin expands over the whole cavity in a state where the flow tip expands in a band shape. On this account, a weld is hardly formed.

However, there is still room for improvement in the forming mold in JP 2014-224602 Ain the following points.

That is, since the recessed-projecting portion, of the insert, by which the female serration is to be formed is a blind alley, air may be kept inside the recessed-projecting portion by the molten resin flowing into the cavity from the film gate and expanding radially inwardly. The air thus kept inside may become high temperature by being compressed at the time of molding and may cause a gas burn mark on the resin or form a flow mark by flowing out to a low-pressure side inside the molten resin. In this case, the inside of the flow mark has a weld shape, and this might cause a decrease in the strength of the pressure container liner.

The present disclosure is accomplished in view of such a problem, and an object of the present disclosure is to provide a technology that can restrain occurrence of gas burn marks or flow marks in a molded product in a forming mold for a pressure container liner and a molding method for a pressure container liner.

In order to achieve the above object, a forming mold for a pressure container liner according to the present disclosure is configured such that an insert by which a female serration is formed is divided in the up-down direction, so that air is released to gaps formed on contacting faces between the inserts divided from each other.

More specifically, the present disclosure is targeted for a forming mold for a pressure container liner having a topped cylindrical shape with an opening formed in a center of a top portion of the pressure container liner, the pressure container liner including a female serration serving as a fitting part to be fitted in a mouth piece, the female serration being formed around the opening of the top portion.

The forming mold includes an insert including a recessed-projecting portion by which the female serration is to be formed, the recessed-projecting portion ranging in a circumferential direction of the forming mold, the insert being configured to form a film gate between the insert and an outer mold, the film gate being connected to a radially outer side of the recessed-projecting portion. The insert includes a lower layer and an upper layer divided from each other in the up-down direction such that an upper end of the recessed-projecting portion becomes part of contacting faces between the upper layer and the lower layer. The lower layer is configured such that the recessed-projecting portion is provided in a radially outer end part of an upper end part of the lower layer. The upper layer has a lower face placed, from above, on an upper face of the lower layer including the recessed-projecting portion. The upper layer and the lower layer have respective bolt holes extending in the up-down direction, the respective bolt holes being formed in respective radially central parts of the upper layer and the lower layer such that a bolt by which the upper layer and the lower layer are fastened to each other is passed through the respective bolt holes. Gaps on the contacting faces between the upper layer and the lower layer are set to a size that allows gas to pass through the gaps but does not allow resin to pass through the gaps. An air-discharge passage via which a vicinal area of the recessed-projecting portion is connected to the bolt holes is formed on the contacting faces.

In this configuration, the film gate is connected to the radially outer side of the recessed-projecting portion, so that molten resin flowing into a cavity from the film gate expands radially outwardly and inwardly inside the cavity without hitting a mold surface of the recessed-projecting portion and without a decrease in a flowing speed. This accordingly makes it possible to restrain occurrence of welds.

Besides, even in a case where air is kept inside a cavity (hereinafter referred to as “recessed-projecting cavity”) defined by the recessed-projecting portion in the lower layer, the lower face of the upper layer, and so on, the air thus kept inside the recessed-projecting cavity can be released to the gaps on the contacting faces between the upper layer and the lower layer because a joint between the upper layer and the lower layer faces the recessed-projecting cavity and the gaps on the contacting faces between the upper layer and the lower layer are set to a size that allows gas to pass through the gaps.

However, the penetration depth of the air into the gaps on the contacting faces has a limit, and therefore, in the present disclosure, the air-discharge passage via which the vicinal area of the recessed-projecting portion is connected to the bolt holes is formed on the contacting faces between the upper layer and the lower layer. By forming the air-discharge passage, the air escaping into the gaps on the contacting faces from the recessed-projecting cavity can be let out to the air-discharge passage near the recessed-projecting portion and can be discharged to the bolt holes through the air-discharge passage. This makes it possible to restrain occurrence of gas burn marks or flow marks in a molded product, thereby making it possible to surely restrain the occurrence of welds.

Since the gaps on the contacting faces between the upper layer and the lower layer are set to a size that does not allow resin to pass through the gaps, even when the joint between the upper layer and the lower layer faces the recessed-projecting cavity, the resin cannot enter the gaps on the contacting faces, thereby making it possible to restrain occurrence of burr and the like.

Further, in the forming mold, the lower layer may include a lower-layer body portion in which recessed outer peripheral surfaces as a radially outer end face of the upper end part of the lower layer form a circumferential surface, and projection portions projecting radially outwardly from the recessed outer peripheral surfaces and having respective upper faces inclined downward as the respective upper faces go radially outwardly. The recessed-projecting portion may be formed such that the projection portions are placed intermittently via the recessed outer peripheral surfaces. An outer-edge lower face as a lower face of a radially outer end part of the upper layer may be inclined at the same inclination as the respective upper faces of the projection portions and extend radially outwardly from projecting outer peripheral surfaces as respective radially outer end faces of the projection portions. The air-discharge passage may include: outer air-discharge grooves formed on contacting faces of the outer-edge lower face with the respective upper faces of the projection portions, the outer air-discharge grooves extending in the circumferential direction on a radially inner side from the projecting outer peripheral surfaces; an inner air-discharge groove formed on a contacting face between the lower face of the upper layer and an upper face of the lower-layer body portion and extending in the circumferential direction on a radially inner side from the recessed outer peripheral surfaces; and first radial air-discharge grooves extending radially so as to connect the outer air-discharge grooves and the inner air-discharge groove to the bolt holes.

In this configuration, the outer-edge lower face is inclined downward as it goes radially outwardly, in other words, the outer-edge lower face becomes higher as it approaches the projecting outer peripheral surfaces and the recessed outer peripheral surfaces. Accordingly, the air easily moving upward in the recessed-projecting cavity can be easily accumulated (collected) in a corner part between the outer-edge lower face and the projecting outer peripheral surface or a corner part between the outer-edge lower face and the recessed outer peripheral surface.

Here, the air-discharge passage formed on the contacting faces between the upper layer and the lower layer includes the outer air-discharge grooves formed on the contacting faces of the outer-edge lower face with the upper faces of the projection portions, the outer air-discharge grooves extending in the circumferential direction on the radially inner side from the projecting outer peripheral surfaces. Accordingly, the air accumulated in the corner part between the outer-edge lower face and the projecting outer peripheral surface can be released to a gap on the contacting face of the outer-edge lower face and the upper face of the projection portion and then let out to the outer air-discharge groove. Further, the air-discharge passage includes the inner air-discharge groove formed on the contacting face between the lower face of the upper layer and the upper face of the lower-layer body portion and extending in the circumferential direction on the radially inner side from the recessed outer peripheral surfaces. Accordingly, the air accumulated in the corner part between the outer-edge lower face and the recessed outer peripheral surface can be released to a gap on the contacting face between the lower face of the upper layer and the upper face of the lower-layer body portion and then let out to the inner air-discharge groove. That is, the outer air-discharge grooves and the inner air-discharge groove correspond to the air-discharge passage near the recessed-projecting portion.

Further, the air-discharge passage includes the first radial air-discharge grooves extending radially so as to connect the outer air-discharge grooves and the inner air-discharge groove to the bolt holes. Accordingly, the air thus let out to the outer air-discharge grooves and the inner air-discharge groove can be discharged to the bolt holes through the first radial air-discharge grooves.

Note that the outer air-discharge grooves, the inner air-discharge groove, and the first radial air-discharge grooves formed on the contacting faces may be formed by forming grooves on the lower face of the upper layer, may be formed by forming grooves on the upper face of the lower layer, or may be formed by forming grooves on both the lower face of the upper layer and the upper face of the lower layer, for example.

In the meantime, in a case where the speed of the molten resin is relatively high, and the resin reaches, earlier than the air, the corner part formed between the outer-edge lower face and the projecting outer peripheral surface or the corner part formed between the outer-edge lower face and the recessed outer peripheral surface, a joint between the outer-edge lower face and the upper face of the projection portion or a joint between the lower face of the upper layer and the upper face of the lower-layer body portion is blocked up with the resin. Accordingly, the air is caught inside, so that the air is easily accumulated on the radially outer side from the projecting outer peripheral surface.

In view of this, in the forming mold, the upper layer may include a second upper layer and a first upper layer divided from each other such that a toric intermediate surface extending in the circumferential direction and extending upward from a generally intermediate part, on the outer-edge lower face, between a radially outer end of the upper layer and the projecting outer peripheral surfaces becomes part of contacting faces between the first upper layer and the second upper layer, the second upper layer having a generally toric shape and placed on the recessed-projecting portion from above, the first upper layer including a generally annular recessed portion in which the second upper layer is fitted. Gaps on the contacting faces between the first upper layer and the second upper layer may be set to a size that allows gas to pass through the gaps but does not allow resin to pass through the gaps. A toric circumferential air-discharge groove and second radial air-discharge grooves may be formed on the contacting faces, the toric circumferential air-discharge groove being formed on the intermediate surface and extending in the circumferential direction above the outer-edge lower face, the second radial air-discharge grooves being grooves via which the circumferential air-discharge groove is connected to the first radial air-discharge grooves.

With this configuration, even in a case where the joint between the outer-edge lower face and the upper face of the projection portion or the joint between the lower face of the upper layer and the upper face of the lower-layer body portion is blocked up with the resin, the air accumulated on the outer-edge lower face between the radially outer end of the upper layer and the projecting outer peripheral surface can be released to a gap on a contacting face (intermediate surface) between the first upper layer and the second upper layer. Since the toric circumferential air-discharge groove is formed on the contacting face between the first upper layer and the second upper layer such that the toric circumferential air-discharge groove extends in the circumferential direction above the outer-edge lower face, the air released to the gap on the contacting face between the first upper layer and the second upper layer can be surely let out to the circumferential air-discharge groove over the whole circumference of the insert.

In addition, since the second radial air-discharge grooves are formed on the contacting faces between the first upper layer and the second upper layer so as to connect the circumferential air-discharge groove to the first radial air-discharge grooves, the air thus let out to the circumferential air-discharge groove can be discharged to the bolt holes through the second radial air-discharge grooves and the first radial air-discharge grooves.

Further, in the forming mold, the pressure container liner may include an opening tubular portion extending downward from a peripheral edge portion of the opening. The lower layer may include a first lower layer and a second lower layer divided in the up-down direction below the recessed-projecting portion, the first lower layer being placed on the upper side and including the recessed-projecting portion, the second lower layer being placed on the lower side and including a columnar portion configured such that a cavity corresponding to the opening tubular portion is formed between the columnar portion and a core. A surface treatment may be performed on an outer peripheral surface of the second lower layer.

With this configuration, since the surface treatment is performed on the outer peripheral surface of the second lower layer including the columnar portion by which a cavity corresponding to the opening tubular portion extending downward is to be formed, the insert can be released from a molded product smoothly. Besides, by dividing the lower layer into the first lower layer and the second lower layer, a range to be subjected to the surface treatment can be restrained to a minimum (the second lower layer including the columnar portion).

Further, in the forming mold, the upper layer may be divided into parts in the circumferential direction such that, when the upper layer is viewed in the up-down direction, surfaces each perpendicular to the circumferential direction and each passing through a corresponding one of circumferential centers of the projecting outer peripheral surfaces and the recessed outer peripheral surfaces in the lower layer serve as contacting faces between the parts. Gaps on the contacting faces between the parts thus divided from each other in the circumferential direction may be set to a size that allows gas to pass through the gaps but does not allow resin to pass through the gaps.

With this configuration, even in a case where the joint between the outer-edge lower face and the upper face of the projection portion or the joint between the lower face of the upper layer and the upper face of the lower-layer body portion is blocked up with resin, the air caught inside can be surely released to gaps on the contacting faces each passing through a corresponding one of the circumferential centers of the projecting outer peripheral surfaces and the recessed outer peripheral surfaces. Hereby, the air thus released to the gaps on the contacting faces and then let out to the outer air-discharge grooves and the inner air-discharge groove can be discharged to the bolt holes through the first radial air-discharge grooves.

Further, in the forming mold, the gaps on the contacting faces may be set to 35 μm to 80 μm.

With this configuration, the contacting faces that allow gas to pass therethrough but does not allow resin to pass therethrough can be easily achieved.

Further, the present disclosure is also targeted for a molding method for a pressure container liner by use of the forming mold described above.

In the molding method, molten resin is filled into a cavity after a pressure in the cavity is decreased by discharging gas from the bolt holes.

With this configuration, by decreasing the pressure in the cavity before the cavity is filled with the molten resin, the air can be let out of the cavity through the contacting faces, and the molten resin can be filled into the cavity smoothly as compared to a case where the internal pressure of the cavity is relatively high.

Further, the present disclosure provides a molding method for a pressure container liner by use of the forming mold described above, and in the molding method, the recessed-projecting portion is filled with molten resin at a relatively low speed.

With this configuration, when the molten resin is filled, at a relatively low speed, into the recessed-projecting portion by which the female serration is to be formed, the air can be surely released from the gaps on the contacting faces, thereby making it possible to further restrain the occurrence of gas burn marks or flow marks in a molded product. Further, by increasing the speed after a flow tip of the molten resin has passed through the recessed-projecting portion, it is possible to prevent the whole molding time from becoming long.

As described above, with the forming mold for a pressure container liner and the molding method for the pressure container liner according to the present disclosure, it is possible to restrain the occurrence of gas burn marks or flow marks in a molded product.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view schematically illustrating a pressure container liner according to Embodiment 1 of the present disclosure;

FIG. 2 is a sectional view schematically illustrating a pressure container;

FIG. 3 is a view schematically illustrating an end part of the pressure container liner in which a mouth piece is fitted;

FIG. 4 is a sectional view schematically illustrating a forming mold for the pressure container liner;

FIG. 5 is a sectional view schematically illustrating an insert;

FIG. 6 is a top view schematically illustrating a lower layer of the insert;

FIG. 7 is a sectional view schematically illustrating an insert according to Embodiment 2 of the present disclosure;

FIG. 8 is a top view schematically illustrating the insert in a state where a first upper layer is removed;

FIG. 9 is a top view schematically illustrating an insert according to Embodiment 3 of the present disclosure;

FIG. 10 is a top view schematically illustrating a lower layer of an insert according to other embodiments;

FIG. 11 is a view to schematically describe a state where air is accumulated in a cavity of a forming mold; and

FIG. 12 is a view to schematically describe a state where air is accumulated in a cavity of the forming mold.

### DETAILED DESCRIPTION OF EMBODIMENTS

With reference to the drawings, the following describes embodiments to carry out the present disclosure.

### Embodiment 1

Pressure Container Liner

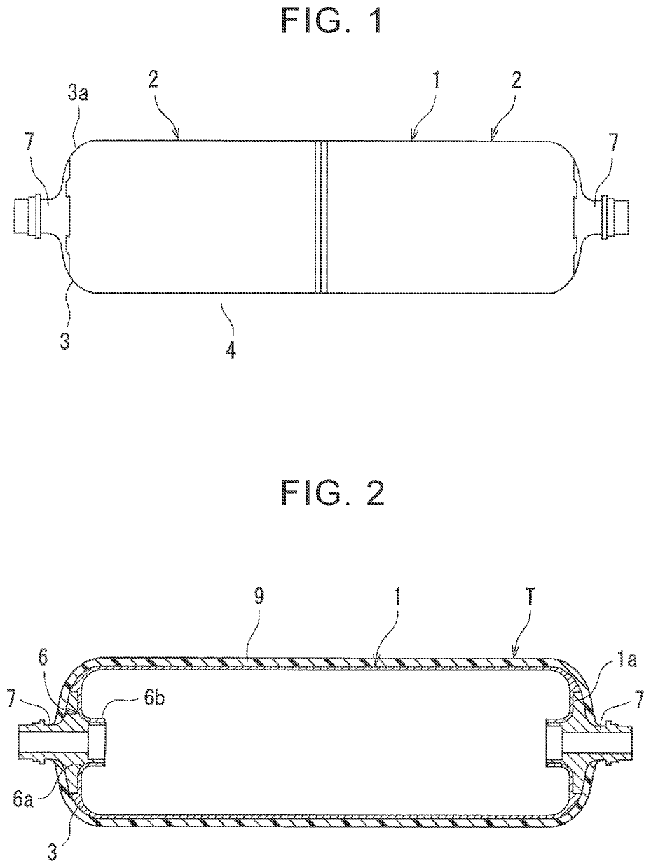

FIG. 1 is a view schematically illustrating a pressure container liner 1 according to the present embodiment, and FIG. 2 is a sectional view schematically illustrating a pressure container T. The pressure container liner 1 (hereinafter just referred to as a “liner 1”) is made of nylon resin and is formed by axially joining (welding) two liner constituent components 2 to each other. The liner constituent components 2 have a topped cylindrical shape and are formed separately by injection molding. The pressure container liner 1 has a cylindrical shape the opposite ends of which are almost closed.

Each of the liner constituent components 2 includes a pipe portion 4 having a linear cylindrical shape and a generally hemispheric dome portion 3 formed in a first end portion of the pipe portion 4. The dome portion 3 is connected to the pipe portion 4 via an R-portion 3a. As illustrated in FIG. 2, a round opening 6 is formed in the center of a top portion of the dome portion 3 (a top portion 1a of the liner 1). The dome portion 3 has an opening tubular portion 6b connected to a peripheral edge portion of the opening 6 via an R-portion 6a. The opening tubular portion 6b extends straight inwardly in the axial direction.

As illustrated in FIG. 2, mouth pieces 7 made of aluminum are fitted in the openings 6 (the opening tubular portions 6b) in the opposite ends of the liner 1, and a carbon fiber 9 is wound and laminated around the outer periphery of the liner 1. Thus, the liner 1 constitutes an inner shell of the pressure container T to be provided in a fuel cell vehicle so that high-pressure hydrogen for power generation is stored in the pressure container T.

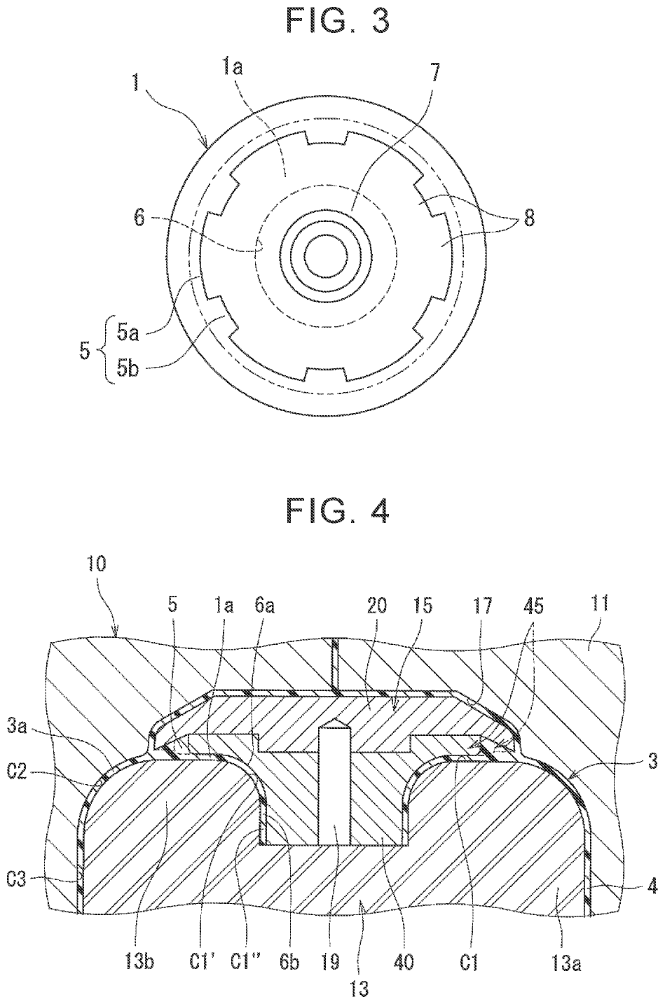

FIG. 3 is a view schematically illustrating an end portion of the liner 1 in which the mouth piece 7 is fitted. As illustrated in FIG. 3, a female serration 5 configured to mesh with a male serration 8 formed on the outer periphery of the mouth piece 7 is provided around the opening 6 on an outer surface of the top portion 1a, so that the mouth piece 7 fitted in the opening tubular portion 6b does not spin. The female serration 5 includes recessed protrusion portions 5a projecting outwardly in the axial direction toward the center of the top portion 1a from an alternate long and two short dashes line in FIG. 3, and projecting protrusion portions 5b projecting outwardly in the axial direction toward the center of the top portion 1a from the alternate long and two short dashes line in FIG. 3 such that the projecting protrusion portions 5b extend to be closer to the center than the recessed protrusion portions 5a. The recessed protrusion portions 5a and the projecting protrusion portions 5b are placed alternately in the circumferential direction of the female serration 5, so that the female serration 5 is formed to serve as part of the generally hemispherical shape.

Forming Mold

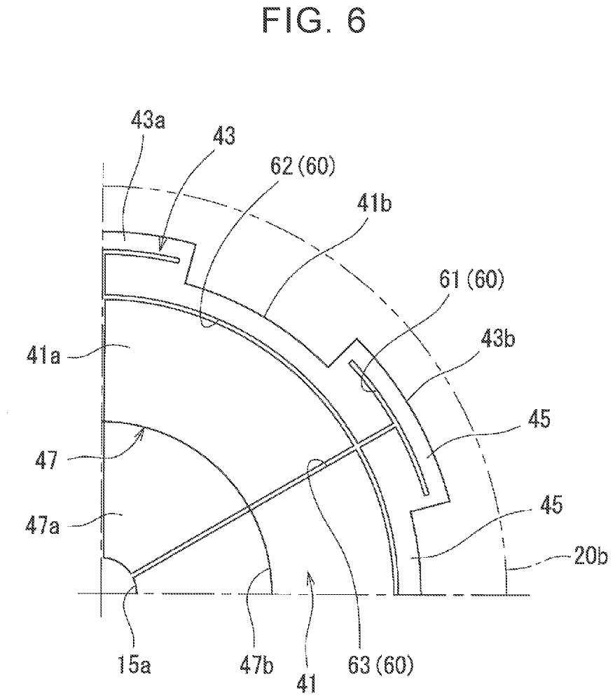

FIG. 4 is a sectional view schematically illustrating a forming mold 10 for the liner 1. Note that, as illustrated in FIG. 4, the liner 1 is molded in a posture in which its axial direction extends in the up-down direction, and the top portion 1a is placed on the upper side. The forming mold 10 includes an outer mold 11, a core (an inner mold) 13 placed inside the outer mold 11, and an insert 15 placed on the upper side of the core 13. The insert 15 is placed in a part where the female serration 5 is to be formed in the forming mold 10 and includes a recessed-projecting portion 45 by which the female serration 5 is to be formed, the recessed-projecting portion 45 ranging in the circumferential direction (see FIG. 6). In other words, the insert 15 includes the recessed-projecting portion 45 hollowed in a shape corresponding to the recessed protrusion portions 5a and the projecting protrusion portions 5b.

As illustrated in FIG. 4, a cavity C3 by which the pipe portion 4 is to be formed is defined by a lower part 13a of the core 13 and the outer mold 11. Further, a cavity C2 by which the R-portion 3a of the dome portion 3 is to be formed is defined by an upper part 13b of the core 13 and the outer mold 11. In the meantime, a cavity C1 by which the top portion 1a, the female serration 5, the R-portion 6a, and the opening tubular portion 6b are to be formed is defined by a lower surface of the insert 15 and the upper part 13b of the core 13. Further, a film gate 17 connected to a radially outer side of the recessed-projecting portion 45 is formed by an upper surface of the insert 15 and the outer mold 11.

In the forming mold 10 of the present embodiment configured as described above, molten resin is poured from the film gate 17 formed between the outer mold 11 and the insert 15 to the whole circumference of the cavity C1 in a film shape, in other words, the molten resin is supplied from the film gate 17 into the cavity C1 at the same time, so that a flow tip of the molten resin expands over the whole cavity C1 in a state where the flow tip expands in a band shape. This reduces branching and merging of the molten resin inside the cavity C1, thereby making it possible to restrain occurrence of welds. Besides, since the film gate 17 is connected to the radially outer side of the recessed-projecting portion 45, the molten resin flowing into the cavity C1 from the film gate 17 expands radially outwardly and inwardly inside the cavity C1 without hitting a mold surface of the recessed-projecting portion 45 and without a decrease in a flowing speed. This makes it possible to more surely restrain the occurrence of welds.

Insert

Since the recessed-projecting portion 45, of the insert 15, by which the female serration 5 is to be formed is a blind alley, air A might be kept inside the recessed-projecting portion 45 by the molten resin flowing into the cavity C1 from the film gate 17 and expanding radially inwardly, as illustrated in FIG. 11. The air A thus kept inside might become high temperature by being compressed at the time of molding and might cause a gas burn mark on the resin or form a flow mark by flowing out to a low-pressure side in the molten resin. In this case, the inside of such a flow mark has a weld shape, and this might cause a decrease in the strength of the liner 1.

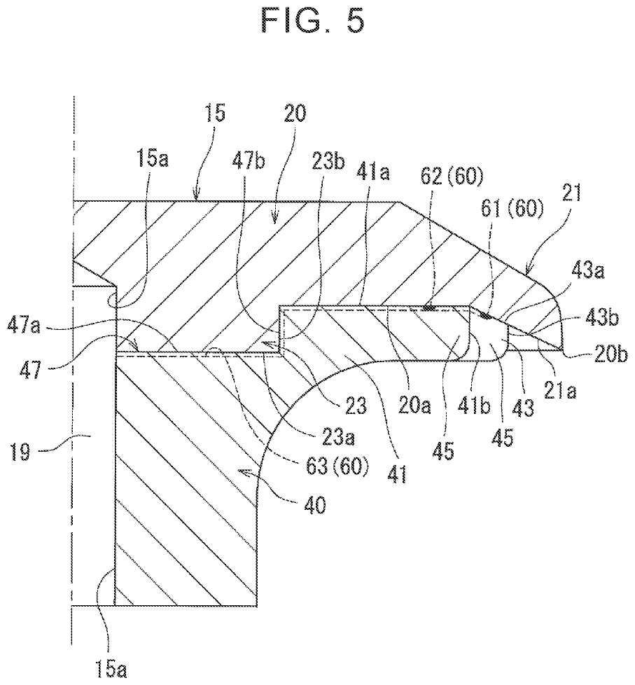

In view of this, in the forming mold 10 for the liner 1 of the present embodiment, the insert 15 is divided in two inserts in the up-down direction, and the air A is released to a contacting face between the divided inserts. FIG. 5 is a sectional view schematically illustrating the insert 15, and FIG. 6 is a top view schematically illustrating a lower layer 40 of the insert 15. The insert 15 includes an upper layer 20 and the lower layer 40 that are divided from each other in the up-down direction, as illustrated in FIG. 5.

The lower layer 40 includes a lower-layer body portion 41 and six projection portions 43. As illustrated in FIG. 5, the lower-layer body portion 41 is formed in a shape in which a discoid upper part, an intermediate part having a reversed truncated cone shape the generating line of which is curved, and a columnar lower part are arranged in this order in the up-down direction. A fitting recessed portion 47 hollowed downward is provided in a radially central part of an upper end part of the lower-layer body portion 41. The fitting recessed portion 47 is hollowed in a columnar shape such that its bottom face 47a is a round flat surface, and its side face 47b is a circumferential surface. By providing such a fitting recessed portion 47, an upper face (hereinafter also referred to as a “lower-layer upper face 41a”) of the lower-layer body portion 41 is a toric flat surface. A radially outer end face (hereinafter also referred to as “recessed outer peripheral surfaces 41b”) of the upper end part of the lower-layer body portion 41 forms a circumferential surface. Further, the radially central part of the lower-layer body portion 41 has a bolt hole 15a extending in the up-down direction and formed in a penetrating manner.

The projection portions 43 project radially outwardly from the recessed outer peripheral surfaces 41b, and upper faces (hereinafter also referred to as “projection-portion upper faces 43a”) of the projection portions 43 are inclined downward as they go radially outwardly from a radially outer end (the recessed outer peripheral surfaces 41b) of the lower-layer upper face 41a. Radially outer end faces (hereinafter also referred to as “projecting outer peripheral surfaces 43b”) of the projection portions 43 form a circumferential surface. The recessed-projecting portion 45 is formed such that six projection portions 43 are placed intermittently via the recessed outer peripheral surfaces 41b, and the recessed-projecting portion 45 is formed in a shape similar to the male serration 8 of the mouth piece 7 (see FIGS. 3, 6 in comparison with each other). That is, the recessed-projecting portion 45 is provided on a radially outer end part of the upper end part of the lower layer 40.

The upper layer 20 is formed generally in a discoid umbrella shape, and a fitting projection portion 23 projecting downward is provided in a radially central part of a lower end part of the upper layer 20. The fitting projection portion 23 is formed in a columnar shape such that its lower face 23a is a round flat surface, and its side face 23b is a circumferential surface. By providing such a fitting projection portion 23, a lower face (hereinafter also referred to as an “upper-layer lower face 20a”) of the upper layer 20 is formed as a toric flat surface. A lower face (hereinafter also referred to as an “outer-edge lower face 21a”) of a radially outer end part 21 of the upper layer 20 is inclined from a radially outer end of the upper-layer lower face 20a at the same inclination as the projection-portion upper faces 43a and extends radially outwardly from the projecting outer peripheral surfaces 43b. Further, a bolt hole 15a extending in the up-down direction is formed in a radially central part of the upper layer 20.

The upper layer 20 and the lower layer 40 formed as described above are positioned to each other by fitting the fitting projection portion 23 of the upper layer 20 in the fitting recessed portion 47 of the lower layer 40 and are fastened to each other by a bolt 19 passed through the bolt holes 15a. As such, when the upper layer 20 and the lower layer 40 are fastened to each other, the lower face (the lower face 23a, the upper-layer lower face 20a, and the outer-edge lower face 21a) of the upper layer 20 is put, from above, on the upper face (the bottom face 47a, the lower-layer upper face 41a, and the projection-portion upper face 43a) of the lower layer 40 including the recessed-projecting portion 45, as illustrated in FIG. 5.

Thus, as illustrated in FIG. 5, in the insert 15, the lower face 23a of the fitting projection portion 23 and the bottom face 47a of the fitting recessed portion 47 constitute a contacting face, the side face 23b of the fitting projection portion 23 and the side face 47b of the fitting recessed portion 47 constitute a contacting face, the upper-layer lower face 20a and the lower-layer upper face 41a constitute a contacting face, and the outer-edge lower face 21a and the projection-portion upper face 43a constitute a contacting face. Therefore, it can be said that the insert 15 of the present embodiment is divided in two in the up-down direction such that the upper end (the lower-layer upper face 41a and the projection-portion upper face 43a) of the recessed-projecting portion 45 becomes part of the contacting faces. Hereby, a joint between the upper-layer lower face 20a and the lower-layer upper face 41a and a joint between the outer-edge lower face 21a and the projection-portion upper face 43a face the cavity C1.

Further, gaps on the contacting faces between the upper layer 20 and the lower layer 40 are set to a size that allows gas to pass through the gaps but does not allow nylon resin to pass through the gaps. More specifically, the gaps on the contacting faces are set to 35 μm to 80 μm.

Since the joints between the upper layer 20 and the lower layer 40 face the cavity C1 and the gaps on the contacting faces between the upper layer 20 and the lower layer 40 are set to a size that allows gas to pass through the gaps, the air A can be released to the gap on the contacting face between the upper-layer lower face 20a and the lower-layer upper face 41a or the gap on the contacting face between the outer-edge lower face 21a and the projection-portion upper face 43a.

The penetration depth of the air A to the gaps on the contacting faces is around 5 mm. Accordingly, in the present embodiment, as illustrated in FIGS. 5, 6, an air-discharge passage 60 via which a vicinal area of the recessed-projecting portion 45 is connected to the bolt holes 15a is formed on the contacting faces between the upper layer 20 and the lower layer 40. The air-discharge passage 60 includes outer air-discharge grooves 61, an inner air-discharge groove 62, and first radial air-discharge grooves 63. Note that, in FIG. 5, the outer air-discharge groove 61 and the inner air-discharge groove 62 are indicated in black, and the first radial air-discharge groove 63 is indicated by a broken line.

As illustrated in FIGS. 5, 6, the outer air-discharge groove 61 is an arcuate groove extending in the circumferential direction and carved on a part of the projection-portion upper face 43a slightly (by less than 5 mm) on the radially inner side from the projecting outer peripheral surface 43b, and the inner air-discharge groove 62 is a toric groove extending in the circumferential direction and carved on a part of the lower-layer upper face 41a slightly (by less than 5 mm) on the radially inner side from the recessed outer peripheral surface 41b. The first radial air-discharge groove 63 is a groove continuously carved over the projection-portion upper face 43a, the lower-layer upper face 41a, and the side face 47b and the bottom face 47a of the fitting recessed portion 47 and extending radially so as to connect the outer air-discharge groove 61 and the inner air-discharge groove 62 to the bolt holes 15a. The first radial air-discharge groove 63 extends radially inwardly from the outer air-discharge groove 61, intersects with the inner air-discharge groove 62, and then extends to the bolt holes 15a.

In the forming mold 10 of the present embodiment configured as described above, the outer-edge lower face 21a and the projection-portion upper face 43a are inclined downward as they go radially outwardly, in other words, the outer-edge lower face 21a becomes higher as it approaches the projecting outer peripheral surface 43b and the recessed outer peripheral surface 41b. Accordingly, the air A that easily moves upward inside the cavity C1 can be easily accumulated (collected) in a corner part formed between the outer-edge lower face 21a and the projecting outer peripheral surface 43b or a corner part formed between the outer-edge lower face 21a and the recessed outer peripheral surface 41b.

Since the joint between the outer-edge lower face 21a and the projection-portion upper face 43a faces the cavity C1, the air A accumulated in the corner part formed between the outer-edge lower face 21a and the projecting outer peripheral surface 43b can be released to the gap on the contacting face between the outer-edge lower face 21a and the projection-portion upper face 43a. Besides, on the contacting face between the outer-edge lower face 21a and the projection-portion upper face 43a, the outer air-discharge groove 61 is formed slightly on the radially inner side from the projecting outer peripheral surface 43b. Accordingly, the air A escaping to the gap on the contacting face between the outer-edge lower face 21a and the projection-portion upper face 43a can be let out to the outer air-discharge groove 61.

Similarly, since the joint between the upper-layer lower face 20a and the lower-layer upper face 41a faces the cavity C1, the air A accumulated in the corner part formed between the outer-edge lower face 21a and the recessed outer peripheral surface 41b can be released to the gap on the contacting face between the upper-layer lower face 20a and the lower-layer upper face 41a. Besides, on the contacting face between the upper-layer lower face 20a and the lower-layer upper face 41a, the inner air-discharge groove 62 is formed slightly on the radially inner side from the recessed outer peripheral surface 41b. Accordingly, the air A escaping to the gap on the contacting face between the upper-layer lower face 20a and the lower-layer upper face 41a can be let out to the inner air-discharge groove 62.

The air A thus let out to the outer air-discharge groove 61 and the inner air-discharge groove 62 is discharged to the bolt holes 15a through the first radial air-discharge groove 63. Accordingly, with the forming mold 10 of the present embodiment, it is possible to restrain the occurrence of gas burn marks or flow marks in a molded product, thereby making it possible to surely restrain the occurrence of welds.

Further, even though the joints between the upper layer 20 and the lower layer 40 face the cavity C1, the gaps on the contacting faces between the upper layer 20 and the lower layer 40 are set to a size that does not allow nylon resin to pass through the gaps. Accordingly, the nylon resin cannot enter the gaps on the contacting faces, thereby making it possible to restrain occurrence of burr or the like.

### Embodiment 2

The present embodiment is different from Embodiment 1 in that the upper layer 20 and the lower layer 40 are each further divided into two. The following mainly describes points different from Embodiment 1. Note that, strictly speaking, the upper layer 20 and the lower layer 40 of the present embodiment are different from the upper layer 20 and the lower layer 40 of Embodiment 1. However, for convenience, common parts will be described with the use of the same reference signs as those used in Embodiment 1.

Upper Layer

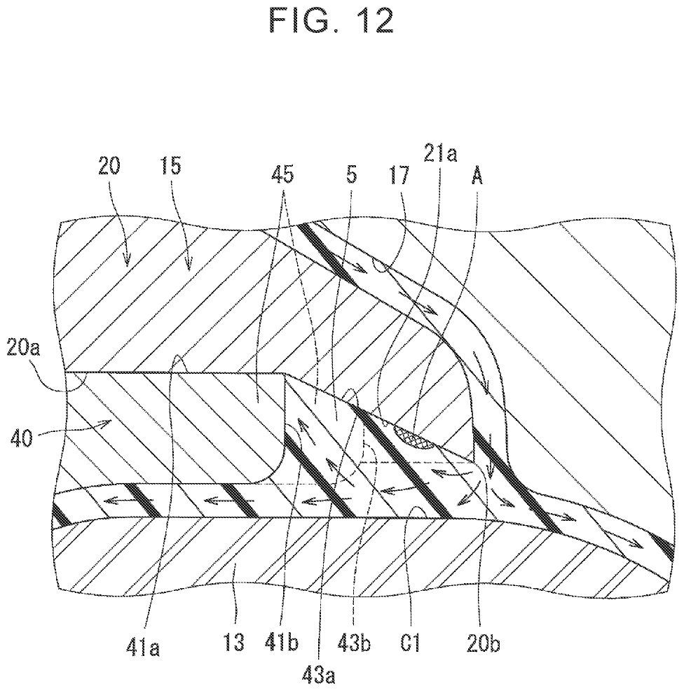

For example, in a case where the speed of the molten resin is relatively high, and the resin reaches, earlier than the air, the corner part formed between the outer-edge lower face 21a and the projecting outer peripheral surface 43b or the corner part formed between the outer-edge lower face 21a and the recessed outer peripheral surface 41b, the joint between the outer-edge lower face 21a and the projection-portion upper face 43a or the joint between the upper-layer lower face 20a and the lower-layer upper face 41a is blocked up with the resin. As a result, the air A is caught inside. In this case, the air A is easily accumulated in a generally intermediate part, on the outer-edge lower face 21a, between a radially outer end 20b of the upper layer 20 and the projecting outer peripheral surface 43b, as illustrated in FIG. 12.

In view of this, in the forming mold 10 of the present embodiment, the upper layer 20 is further divided in two so that a toric intermediate surface extending in the circumferential direction and extending upward from the generally intermediate part (hereinafter also referred to as an “intermediate point MP”), on the outer-edge lower face 21a, between the radially outer end 20b of the upper layer 20 and the projecting outer peripheral surface 43b becomes part of the contacting faces.

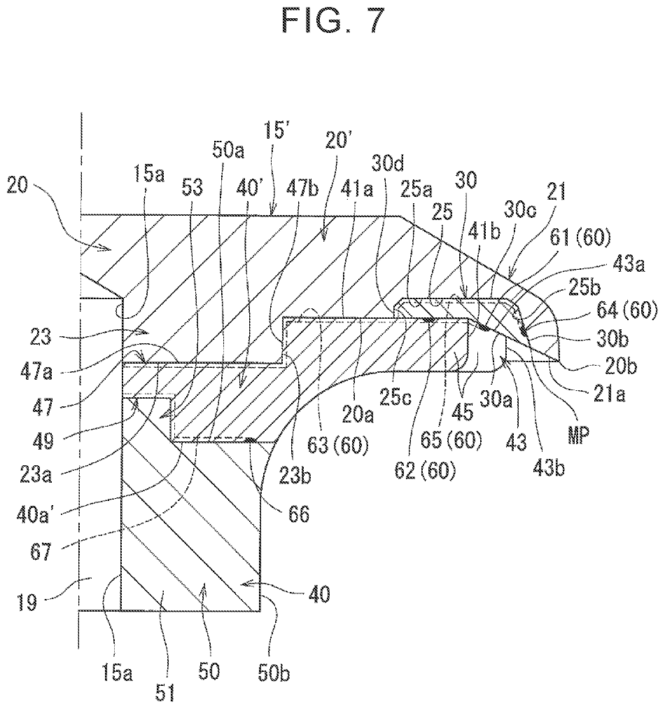

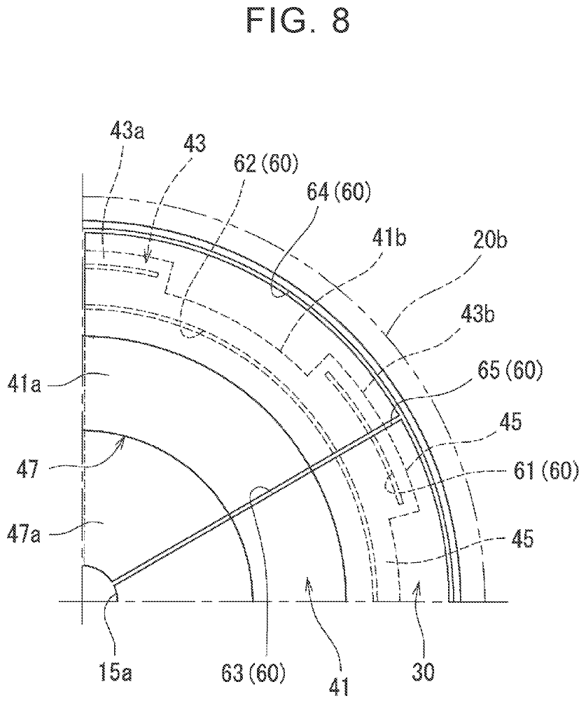

FIG. 7 is a sectional view schematically illustrating an insert 15′ according to the present embodiment, and FIG. 8 is a top view schematically illustrating the insert 15′ in a state where a first upper layer 20′ is removed. As illustrated in FIGS. 7, 8, the upper layer 20 includes a second upper layer 30 having a generally toric shape and put on the recessed-projecting portion 45 from above, and the first upper layer 20′ including an annular recessed portion 25 in which the second upper layer 30 is fitted.

The second upper layer 30 having a generally toric shape includes a lower face 30a, an outer side face (an intermediate face) 30b inclined radially inwardly from the intermediate point MP and extending upward, an upper face 30c as a toric flat surface extending radially inwardly from an upper end of the outer side face 30b, and an inner side face 30d extending downward from a radially inner end of the upper face 30c. Further, the lower face 30a of the second upper layer 30 constitutes a range on the radially outer side from the inner side face 30d of the upper-layer lower face 20a and also constitutes a range on the radially inner side from the intermediate point MP on the outer-edge lower face 21a.

Meanwhile, the first upper layer 20′ has the same shape as the upper layer 20 of Embodiment 1 except that the annular recessed portion 25 hollowed upward is formed.

In the upper layer 20 of the present embodiment, as illustrated in FIG. 7, the outer side face 30b of the second upper layer 30 and an outer side face 25b of the annular recessed portion 25 constitute a contacting face, the upper face 30c of the second upper layer 30 and a top face 25a of the annular recessed portion 25 constitute a contacting face, the inner side face 30d of the second upper layer 30 and an inner side face 25c of the annular recessed portion 25 constitute a contacting face, and the lower face 30a of the second upper layer 30, part of the lower-layer upper face 41a, and the projection-portion upper face 43a constitute a contacting face.

Gaps on the contacting faces between the first upper layer 20′ and the second upper layer 30 are also set to 35 μm to 80 μm and have a size that allows gas to pass through the gaps but does not allow nylon resin to pass through the gaps, similarly to the contacting faces between the upper layer 20 and the lower layer 40 in Embodiment 1. Since the gaps on the contacting faces between the first upper layer 20′ and the second upper layer 30 are set to a size that allows gas to pass through the gaps, the air A can be released to the gap on the contacting face between the outer side face 30b of the second upper layer 30 and the outer side face 25b of the annular recessed portion 25.

Further, on the outer side face 30b of the second upper layer 30, a toric circumferential air-discharge groove 64 is formed (carved) slightly above the outer-edge lower face 21a so as to extend in the circumferential direction. Further, the second upper layer 30 includes second radial air-discharge grooves 65 formed (carved) in the same direction as the first radial air-discharge grooves 63. The second radial air-discharge grooves 65 are provided such that, after the second radial air-discharge grooves 65 extend upward from the circumferential air-discharge groove 64 on the outer side face 30b, the second radial air-discharge grooves 65 extend radially inwardly on the upper face 30c, and then, the second radial air-discharge grooves 65 extend downward on the inner side face 30d so as to be connected to the first radial air-discharge grooves 63. Note that, in FIG. 7, the circumferential air-discharge groove 64 is indicated in black, and the second radial air-discharge groove 65 is indicated by a broken line.

With such a configuration, in the present embodiment, a joint between the outer side face (intermediate face) 30b of the second upper layer 30 and the outer side face 25b of the annular recessed portion 25 faces the cavity C1, and therefore, even in a case where the joint between the outer-edge lower face 21a and the projection-portion upper face 43a or the joint between the upper-layer lower face 20a and the lower-layer upper face 41a is blocked up with resin, the air A can be released from the intermediate point MP to the gap on the contacting face between the outer side face 30b of the second upper layer 30 and the outer side face 25b of the annular recessed portion 25. Besides, on the contacting face between the outer side face 30b of the second upper layer 30 and the outer side face 25b of the annular recessed portion 25, the circumferential air-discharge groove 64 is formed slightly above the outer-edge lower face 21a. Accordingly, the air A escaping to the gap on the contacting face between the outer side face 30b of the second upper layer 30 and the outer side face 25b of the annular recessed portion 25 can be surely let out to the circumferential air-discharge groove 64 over the whole circumference of the insert 15′. The air A thus let out to the circumferential air-discharge groove 64 passes through the second radial air-discharge groove 65 formed in the gap between the second upper layer 30 and the annular recessed portion 25 and then is discharged to the bolt holes 15a through the first radial air-discharge groove 63.

Lower Layer

Further, in the forming mold 10 of the present embodiment, the lower layer 40 is also divided in two in the up-down direction, i.e., a first lower layer 40′ on the upper side and a second lower layer 50 on the lower side, below the recessed-projecting portion 45. The first lower layer 40′ includes a part where the recessed-projecting portion 45 is formed, the part being provided in a radially outer end of the recessed-projecting portion 45, and a part to form a generally upper half of a cavity C1′ (see FIG. 4) corresponding to the R-portion 6a between the part and the core 13. In the meantime, the second lower layer 50 includes a part to form a generally lower half of the cavity C1′ between the part and the core 13, and a columnar portion 51 to form a cavity C1″ (see FIG. 4) corresponding to the opening tubular portion 6b between the columnar portion 51 and the core 13. The first lower layer 40′ and the second lower layer 50 are positioned to each other by fitting a fitting projection portion 53 in a fitting recessed portion 49. The fitting projection portion 53 is formed in an upper end part of the second lower layer 50 so as to project upward, and the fitting recessed portion 49 is formed in a lower end part of the first lower layer 40′ so as to be hollowed upward. Further, the first lower layer 40′ and the second lower layer 50 are fastened to each other by passing the bolt 19 through the bolt holes 15a.

Further, in the lower layer 40, as illustrated in FIG. 7, a lower face 40a′ of the first lower layer 40′ and an upper face 50a of the second lower layer 50 constitute a contacting face, a side face of the fitting recessed portion 49 and a side face of the fitting projection portion 53 constitute a contacting face, and a bottom face of the fitting recessed portion 49 and an upper face of the fitting projection portion 53 constitute a contacting face. Gaps on the contacting faces between the first lower layer 40′ and the second lower layer 50 are set to 35 μm to 80 μm and have a size that allows gas to pass through the gaps but does not allow nylon resin to pass through the gaps. Further, on the lower face 40a′ of the first lower layer 40′, an air-discharge groove 66 is formed (carved) slightly on the radially inner side from an outer peripheral surface of the first lower layer 40′ so as to extend in the circumferential direction. Further, on the lower face 40a′ of the first lower layer 40′ and the side face and the upper face of the fitting projection portion 53, third radial air-discharge grooves 67 via which the air-discharge groove 66 is connected to the bolt holes 15a are formed (carved). Hereby, the air A escaping to the gap on the contacting face between the lower face 40a′ of the first lower layer 40′ and the upper face 50a of the second lower layer 50 can be discharged to the bolt holes 15a. Note that, in FIG. 7, the air-discharge groove 66 is indicated in black, and the third radial air-discharge groove 67 is indicated by a broken line.

Here, as illustrated in FIG. 4, the liner 1 as a molded product has a shape in which the recessed-projecting portion 45, the top portion 1a, and the R-portion 6a can be easily separated from the lower layer 40 in the up-down direction, but the opening tubular portion 6b extending straight cannot be easily separated from the columnar portion 51 of the lower layer 40 in the up-down direction (due to large friction).

In view of this, in the present embodiment, an outer peripheral surface 50b of the second lower layer 50 is subjected to a surface treatment for raising a mold releasability from a molded product. Note that the surface treatment for raising the mold releasability is, for example, to apply a mold releasing agent to the outer peripheral surface 50b of the second lower layer 50, to coat the outer peripheral surface 50b with fluororesin, or to plate the outer peripheral surface 50b. Since the surface treatment is performed on the outer peripheral surface 50b of the second lower layer 50 including the columnar portion 51 by which the cavity C1″ corresponding to the opening tubular portion 6b extending downward is to be formed, the insert 15′ can be released from the molded product smoothly. Besides, since the first lower layer 40′ is divided from the second lower layer 50, a range to be subjected to the surface treatment can be restrained to a minimum (the second lower layer 50 including the columnar portion 51).

Molding Method

In the present embodiment, as described above, the upper layer 20 is divided in two, i.e., the first upper layer 20′ and the second upper layer 30, and the circumferential air-discharge groove 64 and the second radial air-discharge grooves 65 are formed on the contacting faces therebetween. This makes it possible to discharge the air A from the cavity even by a normal molding procedure. However, in order to more surely discharge the air A from the cavity, the following methods may be employed.

Modification 1

In the present modification, in order to improve a gas-discharge function in Embodiment 2, the molten resin is filled into the cavities C1, C1′, C1″ after the pressures in the cavities C1, C1′, C1″ are decreased by discharging gas from the bolt holes 15a.

With the present modification, since the pressures in the cavities C1, C1′, C1″ are decrease before they are filled with the molten resin, the air A can be let out of the cavities C1, C1′, C1″ through the contacting faces, and the molten resin can be filled into the cavities C1, C1′, C1″ smoothly as compared to a case where the internal pressures of the cavities C1, C1″ are relatively high.

Modification 2

The present modification is obtained by modifying Embodiment 2 such that the recessed-projecting portion 45 is filled with the molten resin at a relatively low speed.

With the present modification, by filling the recessed-projecting portion 45 with the molten resin at a relatively low speed, it is possible to restrain such a situation that the joints are blocked up with the resin because the resin reaches, earlier than the air A, a corner part formed between the lower face 30a of the second upper layer 30 and the projecting outer peripheral surface 43b, a corner part formed between the lower face 30a of the second upper layer 30 and the recessed outer peripheral surface 41b, or the intermediate point MP. Accordingly, it is possible to more surely release the air A from the gaps on the contacting faces.

Note that, when the flow tip of the molten resin passes through the recessed-projecting portion 45, the air A is less likely to be kept inside. Accordingly, by increasing the speed of the molten resin after the flow tip of the molten resin has passed through the recessed-projecting portion 45, it is possible to prevent the whole molding time from becoming long.

Further, the method of the present modification may be used in combination with the method in Modification 1.

### Embodiment 3

The present embodiment is different from Embodiment 1 in that the upper layer 20 is divided in the circumferential direction. The following mainly describes points different from Embodiment 1. Note that, strictly speaking, the upper layer 20 of the present embodiment is different from the upper layer 20 of Embodiment 1. However, for convenience, common parts will be described with the use of the same reference signs as those used in Embodiment 1.

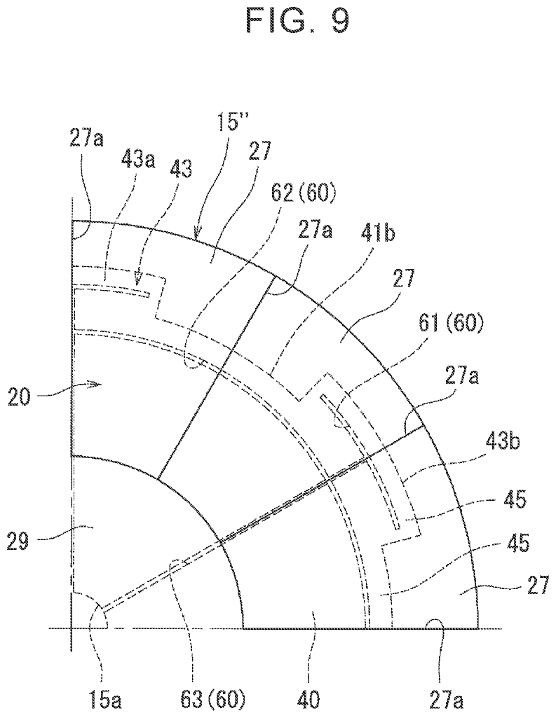

FIG. 9 is a top view schematically illustrating an insert 15″ according to the present embodiment. As illustrated in FIG. 9, when the upper layer 20 is viewed in the up-down direction, the upper layer 20 is divided into 12 parts in the circumferential direction such that surfaces 27a serve as contacting faces. Each of the surfaces 27a passes through a corresponding one of the circumferential centers of six projecting outer peripheral surfaces 43b in the lower layer 40 and the circumferential centers of six recessed outer peripheral surfaces 41b, and the surfaces 27a are perpendicular to the circumferential direction. Note that 12 parts 27 thus divided are held integrally with each other by a pressing lid 29 provided in the radial center of the upper layer 20 so that the parts 27 are not separated from each other.

Similarly to Embodiment 1, gaps on the contacting faces between the parts 27 are also set to 35 μm to 80 μm and have a size that allows gas to pass through the gaps but does not allow nylon resin to pass through the gaps.

In the present embodiment, even in a case where the joint between the outer-edge lower face 21a and the projection-portion upper face 43a or the joint between the upper-layer lower face 20a and the lower-layer upper face 41a is blocked up with the resin, the air A caught inside can be surely released to the gaps on the contacting faces passing through the circumferential centers of the six projecting outer peripheral surfaces 43b and the six recessed outer peripheral surfaces 41b when they are viewed in the up-down direction. Hereby, the air A escaping to the gaps on the contacting faces and then let out to the outer air-discharge grooves 61 and the inner air-discharge groove 62 can be discharged to the bolt holes 15a through the first radial air-discharge grooves 63.

Note that the present embodiment may be also performed in combination with Modification 1 or 2 or Modifications 1, 2, similarly to Embodiment 2.

### Other Embodiments

The present disclosure is not limited to the above embodiments and can be carried out in other various forms without departing from the spirit or main feature of the present disclosure.

In Embodiment 1, the outer air-discharge grooves 61, the inner air-discharge groove 62, and the first radial air-discharge grooves 63 formed on the contacting faces are formed in the lower layer 40. However, the outer air-discharge grooves 61, the inner air-discharge groove 62, and the first radial air-discharge grooves 63 are not limited to this and may be formed in the upper layer 20 or may be formed in both the upper layer 20 and the lower layer 40.

Further, in Embodiment 2, the circumferential air-discharge groove 64 and the second radial air-discharge grooves 65 formed on the contacting faces are formed in the second upper layer 30. However, the circumferential air-discharge groove 64 and the second radial air-discharge grooves 65 are not limited to this and may be formed in the annular recessed portion 25 of the first upper layer 20′ or may be formed in both the annular recessed portion 25 of the first upper layer 20′ and the second upper layer 30.

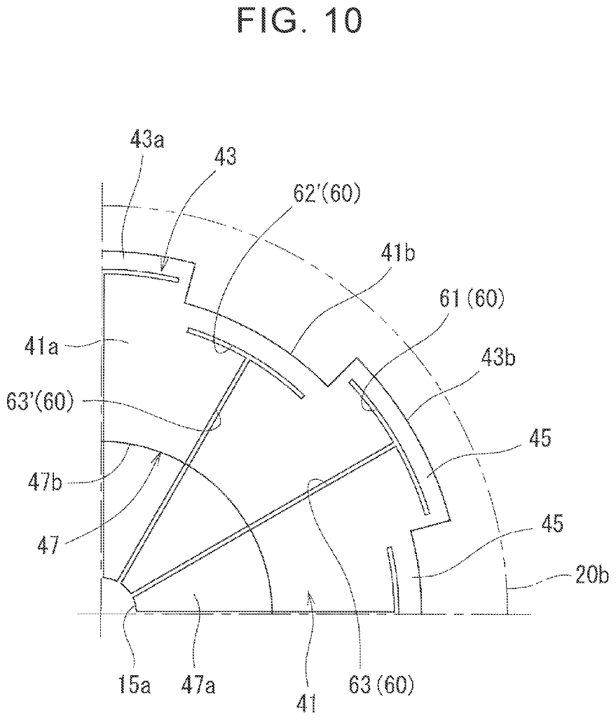

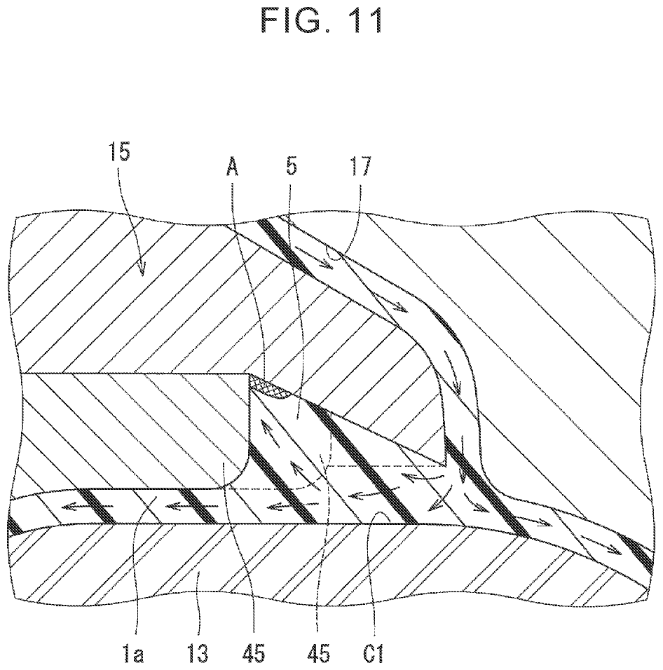

Further, in Embodiment 1, the inner air-discharge groove 62 is formed in a toric shape extending in the circumferential direction. However, the inner air-discharge groove 62 is not limited to this. As illustrated in FIG. 10, inner air-discharge grooves 62′ may be formed in an arcuate shape extending in the circumferential direction, and radial air-discharge grooves 63′ via which the inner air-discharge grooves 62′ are connected to the bolt holes 15a may be formed.

Thus, the above embodiments are just examples in every respect and must not be interpreted restrictively. Further, modifications and alterations belonging to an equivalent range of Claims are all included in the present disclosure.

With the present disclosure, it is possible to restrain the occurrence of gas burn marks or flow marks in a molded product. Accordingly, the present disclosure is very useful when it is applied to a forming mold for a pressure container liner including a female serration on an upper face of a top portion and a molding method for the pressure container liner.

What is claimed is:

1. A forming mold for a pressure container liner having a topped cylindrical shape with an opening formed in a center of a top portion of the pressure container liner, the pressure container liner including a female serration serving as a fitting part to be fitted in a mouth piece, the female serration being formed around the opening of the top portion, the forming mold comprising an insert including a recessed-projecting portion by which the female serration is to be formed, the recessed-projecting portion ranging in a circumferential direction of the forming mold, the insert being configured to form a film gate between the insert and an outer mold, the film gate being connected to a radially outer side of the recessed-projecting portion, wherein:
the insert includes a lower layer and an upper layer divided from each other in an up-down direction such that an upper end of the recessed-projecting portion becomes part of contacting faces between the upper layer and the lower layer,
the lower layer being configured such that the recessed-projecting portion is provided in a radially outer end part of an upper end part of the lower layer,
the upper layer having a lower face placed, from above, on an upper face of the lower layer including the recessed-projecting portion;
the upper layer and the lower layer have respective bolt holes extending in the up-down direction, the respective bolt holes being formed in respective radially central parts of the upper layer and the lower layer such that a bolt by which the upper layer and the lower layer are fastened to each other is passed through the respective bolt holes;
gaps on the contacting faces between the upper layer and the lower layer are set to a size that allows gas to pass through the gaps but does not allow resin to pass through the gaps; and
an air-discharge passage via which a vicinal area of the recessed-projecting portion is connected to the bolt holes is formed on the contacting faces.

2. The forming mold according to claim 1, wherein:
the lower layer includes
a lower-layer body portion in which recessed outer peripheral surfaces as a radially outer end face of the upper end part of the lower layer form a circumferential surface, and
projection portions projecting radially outwardly from the recessed outer peripheral surfaces and having respective upper faces inclined downward as the respective upper faces go radially outwardly;
the recessed-projecting portion is formed such that the projection portions are placed intermittently via the recessed outer peripheral surfaces;
an outer-edge lower face as a lower face of a radially outer end part of the upper layer is inclined at the same inclination as the respective upper faces of the projection portions and extends radially outwardly from projecting outer peripheral surfaces as respective radially outer end faces of the projection portions; and
the air-discharge passage includes
outer air-discharge grooves formed on contacting faces of the outer-edge lower face with the respective upper faces of the projection portions, the outer air-discharge grooves extending in the circumferential direction on a radially inner side from the projecting outer peripheral surfaces,
an inner air-discharge groove formed on a contacting face between the lower face of the upper layer and an upper face of the lower-layer body portion and extending in the circumferential direction on a radially inner side from the recessed outer peripheral surfaces, and
first radial air-discharge grooves extending radially so as to connect the outer air-discharge grooves and the inner air-discharge groove to the bolt holes.

3. The forming mold according to claim 2, wherein:
the upper layer includes a second upper layer and a first upper layer divided from each other such that a toric intermediate surface extending in the circumferential direction and extending upward from a generally intermediate part, on the outer-edge lower face, between a radially outer end of the upper layer and the projecting outer peripheral surfaces becomes part of contacting faces between the first upper layer and the second upper layer, the second upper layer having a generally toric shape and placed on the recessed-projecting portion from above, the first upper layer including a generally annular recessed portion in which the second upper layer is fitted;
gaps on the contacting faces between the first upper layer and the second upper layer are set to a size that allows gas to pass through the gaps but does not allow resin to pass through the gaps; and
a toric circumferential air-discharge groove and second radial air-discharge grooves are formed on the contacting faces, the toric circumferential air-discharge groove being formed on the intermediate surface and extending in the circumferential direction above the outer-edge lower face, the second radial air-discharge grooves being grooves via which the circumferential air-discharge groove is connected to the first radial air-discharge grooves.

4. The forming mold according to claim 1, wherein:
the pressure container liner includes an opening tubular portion extending downward from a peripheral edge portion of the opening;
the lower layer includes a first lower layer and a second lower layer divided in the up-down direction below the recessed-projecting portion, the first lower layer being placed on an upper side and including the recessed-projecting portion, the second lower layer being placed on a lower side and including a columnar portion configured such that a cavity corresponding to the opening tubular portion is formed between the columnar portion and a core; and
a surface treatment is performed on an outer peripheral surface of the second lower layer.

5. The forming mold according to claim 2, wherein:
the upper layer is divided into parts in the circumferential direction such that, when the upper layer is viewed in the up-down direction, surfaces each perpendicular to the circumferential direction and each passing through a corresponding one of circumferential centers of the projecting outer peripheral surfaces and the recessed outer peripheral surfaces in the lower layer serve as contacting faces between the parts; and
gaps on the contacting faces between the parts thus divided from each other in the circumferential direction are set to a size that allows gas to pass through the gaps but does not allow resin to pass through the gaps.

6. The forming mold according to claim 1, wherein the gaps on the contacting faces are set to 35 μm to 80 μm.

7. A molding method for a pressure container liner by use of the forming mold according to claim 1, wherein molten resin is filled into a cavity after a pressure in the cavity is decreased by discharging gas from the bolt holes.

8. A molding method for a pressure container liner by use of the forming mold according to claim 1, wherein the recessed-projecting portion is filled with molten resin at a relatively low speed.
